(19) United States
(12) Patent Application Publication
(10) Pub. No.: US 2026/0284971 A1
(43) Pub. Date: Sep. 24, 2026

(54) PRODUCTION APPARATUS FOR ADDITIVE MANUFACTURING OF THREE-DIMENSIONAL WORKPIECES, BUILD CYLINDER FOR USE WITH THE PRODUCTION APPARATUS, AND PRODUCTION SYSTEM AND METHOD

(71) Applicant: Nikon SLM Solutions AG, Luebeck (DE)

(72) Inventor: Kai BURFEIND, Luebeck (DE)

(21) Appl. No.: 19/480,203

(22) PCT Filed: Apr. 30, 2024
(86) PCT No.: PCT/EP2024/061898

§ 371 Date: Oct. 30, 2025

(30) Foreign Application Priority Data
May 10, 2023 (DE) 102023112250.9

(51) Int. Cl. B29C 64/245; B29C 64/153; B33Y 30/00; B33Y 99/00

(52) U.S. Cl. CPC B29C 64/245; B29C 64/153; B33Y 30/00; B33Y 99/00

(57) ABSTRACT

The invention relates to a production apparatus for additive manufacturing of three-dimensional workpieces, comprising a solidifying device which is configured to selectively solidify powder material, wherein the production apparatus is configured for use with an exchangeable build cylinder designed to receive at least partially solidified powder material, wherein the production apparatus comprises a coupling system for coupling to the build cylinder, which is designed to orient the build cylinder in a predefined position and to hold same in the predefined position at least during part of a production process. The invention also relates to a corresponding build cylinder, to a production system and to a method.

The present disclosure relates to a production apparatus for additive manufacturing of three-dimensional workpieces, to a build cylinder for use with this production apparatus, to a production system and to a method.

In the field of additive manufacturing by powder bed fusion, three-dimensional workpieces can be manufactured by selective solidification of powder material. The pulverulent raw material to be solidified is mostly received by a build cylinder, which is delimited at the bottom by a build plate. At the start of a production process, the build plate is positioned at the top of the build cylinder and is covered with a powder layer. After the selective solidification of this powder layer by a solidifying device, the build plate is moved downward in the build cylinder, whereby the at least partially solidified powder layer is likewise moved downward. A further powder layer can then be applied to the at least partially solidified layer and can in turn be solidified in the desired regions. The three-dimensional workpiece is thus formed layer by layer.

The raw material can be a metal, a metal alloy or a plastics material. Other powder materials such as, for example, cell-based raw materials are also conceivable. There can be used as solidifying devices, for example, irradiation devices, which selectively melt the powder material by a beam that can be guided over the layer. The beam can be a particle beam, for example an electron beam, or electromagnetic radiation, for example laser light. In particular, the solidifying device can be adapted to solidify the powder material by selective laser sintering or selective laser melting. Alternatively or in addition, the solidifying device that is used can be designed to apply a binder, for example an adhesive, to the layer regions to be solidified in order to selectively solidify the powder.

In the present case there is provided a generic production apparatus for additive manufacturing of three-dimensional workpieces, said production apparatus comprising a solidifying device that is adapted to selectively solidify powder material.

Unlike some known solutions which utilize a build cylinder that is permanently connected to the production apparatus, the production apparatus provided here is adapted for use with an exchangeable build cylinder designed to receive at least partially solidified powder material. The build cylinder provided here is thus not permanently connected to the production apparatus but can be exchanged in particular for a structurally identical and/or empty build cylinder. The partially solidified powder material can correspond to an at least partially solidified powder layer.

The production apparatus described here comprises a coupling system for coupling with the build cylinder. This coupling system serves in particular to releasably couple the exchangeable build cylinder to the production apparatus.

The coupling system is designed to orient the build cylinder in a predetermined position. Orientation in the predetermined position can ensure that a powder layer introduced into the coupled-on build cylinder has a known location in space. The layer can thus be selectively solidified with high location accuracy.

The predetermined position can be defined in particular relative to the production apparatus and/or at least part of the production apparatus. For example, the predetermined position is defined in relation to the solidifying device and/or a process chamber of the production apparatus. The process chamber can be designed to ensure an atmosphere with predefined temperature, flow, humidity and/or chemical properties, in particular a protecting gas atmosphere, above the powder bed or the uppermost powder layer.

The coupling system is further designed to hold the build cylinder in the predetermined position at least during part of a production process. The coupling system accordingly fulfils an advantageous dual function, since it serves on the one hand to orient the build cylinder and on the other hand also to hold the build cylinder.

In particular, the coupling system is designed to bear a large part of the weight of the build cylinder, or even the entire weight of the build cylinder, when it holds the build cylinder. By contrast, the weight of the build plate and of the powder material, in particular selectively solidified powder material, optionally located on the build plate and within the build cylinder can be borne, for example at least temporarily, by another structural element, in particular by a drive device for moving the build plate, when the coupling system is holding the build cylinder. The coupling system can be designed to releasably hold the exchangeable build cylinder on the production apparatus. The production process is in particular a production process for additive manufacturing of a three-dimensional workpiece carried out by the production apparatus. It is conceivable for the coupling system to hold the build cylinder throughout the entire production process.

The coupling system can be adapted to orient an upper end portion of the build cylinder in the predetermined position. The coupling system can be adapted to hold the build cylinder at the upper end portion at least during the part of the production process. This in turn allows a powder layer which has been introduced into the coupled-on build cylinder and is located in the upper end portion to have a known location in space, so that this layer can be selectively solidified with high location accuracy.

The coupling system can be designed to hold the build cylinder from above and/or in a suspended manner. In this case, the build cylinder in the coupled state can be said to be suspended from the coupling system. The coupling system can be designed to come into contact with the build cylinder (e.g. only) from above, or to come into contact (e.g. only) with an upper side of the at least part of the build cylinder, in particular in order to hold the build cylinder. The build cylinder can have one or more projections which are arranged on the outer circumferential side and are designed for coupling to the coupling system. The at least one part of the build cylinder can comprise one or more of these projections. The production apparatus can be designed such that the upper end portion of the build cylinder is hermetically connected to the process chamber when it is coupled to the production apparatus via the coupling system. The upper end portion can be designed to be connected to the process chamber in particular in a gas- and/or pressure-tight manner via a sealing system of the production apparatus. The upper end portion can be closer to the solidifying device than a lower end portion of the build cylinder when the build cylinder is coupled to the production apparatus. The upper end portion can be designed to receive a new powder layer, while a lower end portion of the build cylinder is designed to receive a powder layer that has already been selectively solidified. The one or more projections can be part of the upper end portion of the build cylinder. Unless described otherwise, the indications “top” and “bottom” and corresponding designations such as, for example, “upper side” and “lower side” are to be understood in relation to the direction of gravity. Objects in free fall move from top to bottom under the effect of gravity.

The coupling system can be designed in such a manner that the build cylinder is to be moved in an infeed direction for coupling with the coupling system. The coupling system can be adapted to orient the build cylinder into the predetermined position while it is being moved in the infeed direction. Simple and position-accurate coupling of the build cylinder in the predetermined position is thereby made possible. In particular, this makes it possible to use a drive device that is able to move the build cylinder in only one spatial direction, namely in the infeed direction, while the orientation in at least one further spatial direction takes place by the coupling system.

The predetermined position can be different from a position that the build cylinder is able to reach when it is moved along the infeed direction. The orientation can take place in a direction that is different from the infeed direction. The infeed direction can run linearly and/or from bottom to top. The infeed direction can run in the direction of the process chamber and/or solidifying device. The coupling system can be designed to center the build cylinder into the predetermined position while the build cylinder is being moved in the infeed direction. For example, the coupling system can be designed such that the build cylinder is oriented or centered in the x-y plane while it is being moved in the z-direction (infeed direction). This orientation or centering can be effected by means of bolts which run substantially in the z-direction and are provided as part of the coupling system and which, during coupling of the build cylinder to the coupling system, engage into corresponding recesses in the build cylinder or vice versa.

The coupling system can comprise a plurality of clamping systems. One, multiple or each of the clamping systems can be adapted to hold the build cylinder in the predetermined position at least during the part of the production process. This allows the build cylinder to be coupled quickly to the production apparatus using inexpensive means which nevertheless provide the desired dual function of orientation and holding.

Such a clamping system comprises in a first variant in particular a clamping module. The clamping module can be designed to clamp a matching counter-piece, in particular a clamping means such as, for example, a (clamping) bolt, wherein the counter-piece is connected or fastened to the build cylinder. In a second variant, such a clamping system comprises a clamping means which is designed for coupling to a matching counter-piece, in particular a clamping module, wherein the counter-piece is again connected or fastened to the build cylinder. A combination of both variants is also conceivable, wherein the coupling module would then comprise different clamping systems, namely not only at least one clamping module but also at least one clamping means for coupling in each case with a matching counter-piece.

The plurality of clamping systems can comprise three or more clamping systems. The three or more clamping systems can be arranged in a substantially equally distributed manner, in particular along an outer circumferential line of the build cylinder when the build cylinder is being held by the coupling system. The use of three or more clamping systems can permit highly accurate orientation or positioning of the build cylinder.

The plurality of clamping systems can comprise one or more zero point clamping systems. It is possible to design a single clamping system as a zero point clamping system or to design multiple clamping systems such that they form a zero point clamping system (e.g. only) in combination. It is also conceivable for the totality of the clamping systems to form a single zero point clamping system. The zero point can in each case correspond to the predetermined position. A zero point clamping system is suitable in particular for the precise orientation and holding of the build cylinder.

The clamping systems of the plurality of clamping systems can be arranged on different sides (e.g. on all the outer sides) of the build cylinder when the build cylinder is oriented in the predetermined position. In other words, the clamping systems of the plurality of clamping systems can be arranged such that they are located on different sides of the build cylinder when the build cylinder is oriented in the predetermined position. The clamping systems can be arranged at different (e.g. outer) corners of the build cylinder (e.g. at all the outer corners). Such an arrangement of the clamping systems can permit reliable orientation and holding of the build cylinder.

The clamping systems of the plurality of clamping systems can each be displaceably mounted (e.g. only) on a line, wherein the line intersects a central axis of the build cylinder when the build cylinder is oriented in the predetermined position. The central axis can run in the vertical direction of the build cylinder. In other words, there can be provided multiple clamping systems which can be displaced (e.g. in the x-y plane) toward the central axis and away from the central axis but cannot move in other spatial directions. This allows the central axis to continue to be held in the predetermined position even in the event of a temperature-related expansion or contraction of the coupled-on build cylinder.

The clamping systems of the plurality of clamping systems can be designed so as to be controllable pneumatically via at least two independent fluid circuits. The clamping systems can be divided into at least two groups, each of which is connected to a group-specific fluid circuit and is controllable via that circuit. By application of pressure (e.g. via the corresponding fluid circuit), such pneumatic clamping systems can be controlled, that is to say in particular opened, closed, locked, unlocked, cleaned and/or re-tightened. The use of multiple fluid circuits can here create a certain redundancy, so that in the event of failure of only one fluid circuit at least the clamping systems connected to other fluid circuits continue to be controllable.

The clamping systems of the plurality of clamping systems can be configured so as to be normally clamped. It is thus possible to provide one or more clamping systems which remain clamped in the absence of an electrical, mechanical or pneumatic control signal. There are suitable for this purpose, for example, clamping systems with integrated spring mechanisms, which hold or/and lock the clamping system in the clamped state after clamping of a clamping means. Normally clamped clamping systems have the advantage that a clamped clamping means continues to be clamped even in the case of a power failure or failure of an electrical or pneumatic (fluid) control line. This can ensure, in the present case, that the build cylinder is securely held on the production apparatus even in the presence of such a failure.

The production apparatus can comprise a support device. The predetermined position can be defined relative to the support device. The support device can be designed to carry the coupling system, the process chamber and/or the solidifying device. The support device can be designed such that a weight held by the coupling device, for example the weight of the build cylinder that is being held, does not have any effect on the spatial location, in particular the position and/or orientation, of the solidifying device and/or of the process chamber. It can thus be ensured that the coupled-on build cylinder has a predetermined location relative to the solidifying device and/or the process chamber. This in turn allows location-accurate selective solidification of the powder material.

The coupling system can comprise one or more functional interfaces for connection to matching functional interfaces of the build cylinder. A functional interface is here to be understood as being in particular an electrical interface or a fluidic interface. The electrical interface can be designed to supply power to electrical components of the build cylinder or/and to transmit data. In particular, the electrical interface can serve for the contacting of one or more (e.g. temperature, deformation and/or weight) sensors of the build cylinder. The fluidic interface can be designed to provide a pneumatic control signal for pneumatic actuators of the build cylinder. Alternatively or in addition, it can also serve to supply the build cylinder with a heating or cooling medium. The functional interface can be designed as a quick connection, which in particular is connected to a corresponding counter-interface of the build cylinder when the build cylinder is in the predetermined position.

There is further provided a build cylinder for use with the production apparatus. The build cylinder can have the features already described.

The build cylinder can be designed as a general hollow cylinder. The build cylinder can be polygonal, that is to say can have a polygon-shaped outer contour and/or inner contour. Correspondingly, a hollow interior of the build cylinder can have a polygon-shaped outer contour. The polygon can be in particular a rectangle or square. The build cylinder can extend linearly in the vertical direction.

In particular, the build cylinder can comprise multiple clamping elements, which are designed for coupling with clamping systems of the coupling system. The clamping elements can be arranged on different sides (e.g. on two opposite or all the outer sides) of the build cylinder. Alternatively or in addition, it is conceivable for one or more of the clamping elements to be displaceably mounted on a line, wherein the line intersects the central axis of the build cylinder. As already described above, this can compensate for a temperature-based change in size of the build cylinder in that the central axis of the coupled-on build cylinder remains in the predetermined position. As in the case of the clamping systems, a clamping element can comprise a clamping module or a clamping means. The build cylinder can have different clamping elements, that is to say also combinations of clamping modules and clamping means.

The build cylinder can comprise one or more interfaces, which are designed for connection to the functional interface(s) of the coupling system. As outlined above, these can be electrical and/or fluidic interfaces. The build cylinder can comprise an electrical heating and/or cooling system, which can be supplied with power and/or controlled via the electrical interface. The build cylinder can comprise a fluid conducting system, and a fluid interface for connection to a matching fluid interface of the coupling system and configured to supply the fluid conducting system. The fluid conducting system can be designed to regulate a temperature of the build cylinder, in particular as a heating and/or cooling system. The build cylinder can comprise a second fluid interface for delivering a fluid from the fluid conducting system. The second fluid interface can again be configured for connection to a matching fluid interface of the coupling system. Regulation of the temperature of the build cylinder via the coupling system is thus made possible.

The build cylinder has in particular the upper end portion and an opposite lower end portion. A locking system can be arranged at the lower end portion, said locking system being adapted to lock, relative to the build cylinder, a build plate that is displaceably mounted (e.g. in the vertical direction) in a powder receiving chamber or interior of the build cylinder.

There is further provided a production system which comprises the production apparatus and the build cylinder.

The production apparatus and/or the production system can further comprise a drive device, which is adapted to raise the build plate. The drive device can be designed in particular to raise the build plate while the build plate is locked by the locking system, in order to move the build cylinder in the infeed direction for coupling with the coupling system. In other words, the drive device can be used either to raise the locked build plate and the build cylinder or to raise the unlocked build plate while the build cylinder is being held by the coupling system. To this end, the drive device can be coupled to the build plate. A force transmission from the drive device to the build cylinder can be ensured by the locking system. The use of a single drive device is thus sufficient to couple the build cylinder to the production apparatus and to move the build plate during the production process. The size of the production apparatus and/or of the production system can thus be reduced.

It is conceivable for the drive device to be movably coupled (e.g. in translation or/and in rotation) to the build plate. In particular, the drive device can be coupled to the build plate translationally in the x-y plane. In this case, the drive device can be displaced in the x-y plane without effecting a corresponding displacement of the build plate. The build plate can be mounted in the build cylinder so as to be movable in translation (e.g. solely) in the z-direction. A coupling of the drive device to the build plate that is movable in the x-y plane can in this case reduce frictional forces acting on the build plate in the x-y plane. It can additionally or alternatively be provided that the drive device is coupled to the build plate so as to be movable in rotation, for example rotatable at least about the x- and the y-axis. Torsional loads on the build plate can thus be reduced.

Coupling of the drive device to the build plate is to be understood as meaning direct or indirect coupling. In the case of direct coupling, the drive device is in contact with the build plate, while in the case of indirect coupling, the build plate is carried by a carrier plate, wherein the drive device is in direct contact with the carrier plate. In the latter case, the carrier plate functions, as it were, as an intermediate member between the drive device and the build plate. It will be appreciated that, for movable coupling of the drive device to the build plate, the carrier plate can be movable in relation to the build plate or/and the carrier plate can be movable in relation to the drive device.

In a particular example, the coupling system 24 is designed such that it holds the build cylinder in the coupled-on state so that it is movable in translation within a predetermined translation range (e.g. along at least one of the three spatial axes). In this case, the coupling system is thus designed to hold the build cylinder in the predetermined position with a predetermined tolerance of in particular a few millimeters.

A method is further provided. The method uses the build cylinder and the production apparatus and serves in particular for coupling the build cylinder to the production apparatus. The method comprises moving the build cylinder in the infeed direction. The build cylinder is oriented into the predetermined position by the coupling system while it is being moved in the infeed direction. The method further comprises holding the build cylinder in the predetermined position by the coupling system, at least during part of the production process. In the method, the build cylinder can be moved in the infeed direction in that the build plate displaceably mounted in the interior of the build cylinder is raised while the build plate is locked relative to the build cylinder. The method can further comprise one or more of the steps described above. The method can comprise in particular at least one of the following steps: unlocking the build plate after the build cylinder has been coupled to the coupling system; moving the unlocked build plate upward in the coupled-on build cylinder; applying powder material to the build plate; selectively solidifying a powder layer; carrying out the whole or part of the production process; locking the build cylinder on completion of the production process; moving the build cylinder in the opposite direction to the infeed direction in order to uncouple the build cylinder from the coupling system; controlling the clamping systems and/or clamping elements; supplying power or fluid to the functional interfaces. The production apparatus and/or the production system can comprise a control device which controls the production apparatus and/or the production system such that the method is carried out.

Exemplary embodiments will be described hereinbelow with reference to the figures, in which

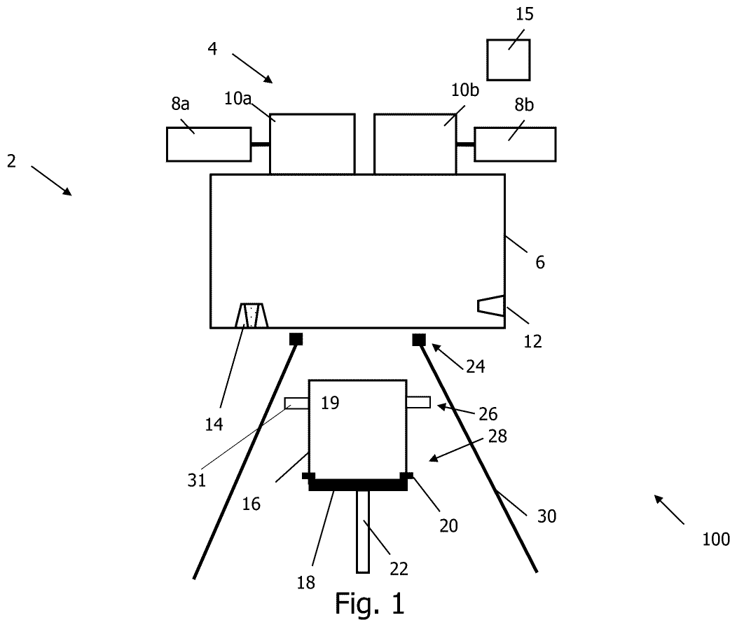

FIG. 1 shows a schematic drawing of a production system with the build cylinder uncoupled;

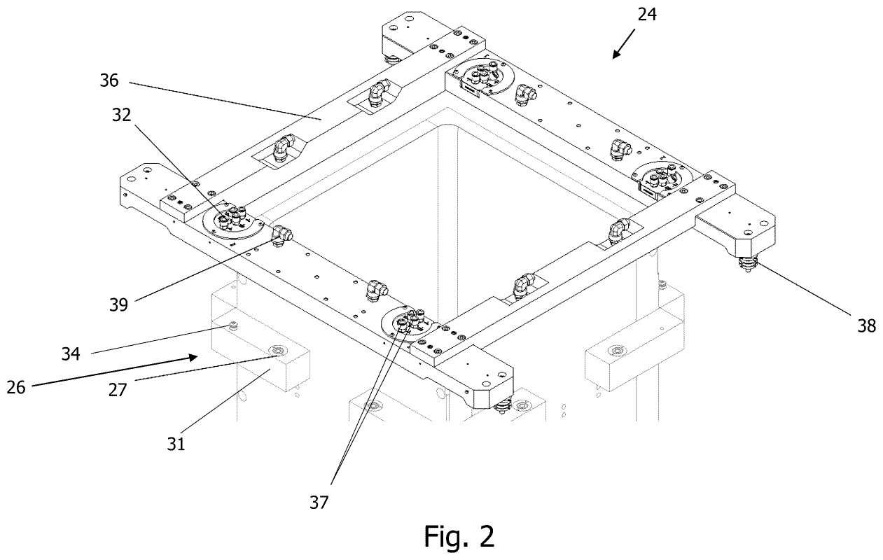

FIG. 2 shows a perspective view of a coupling system with the build cylinder uncoupled;

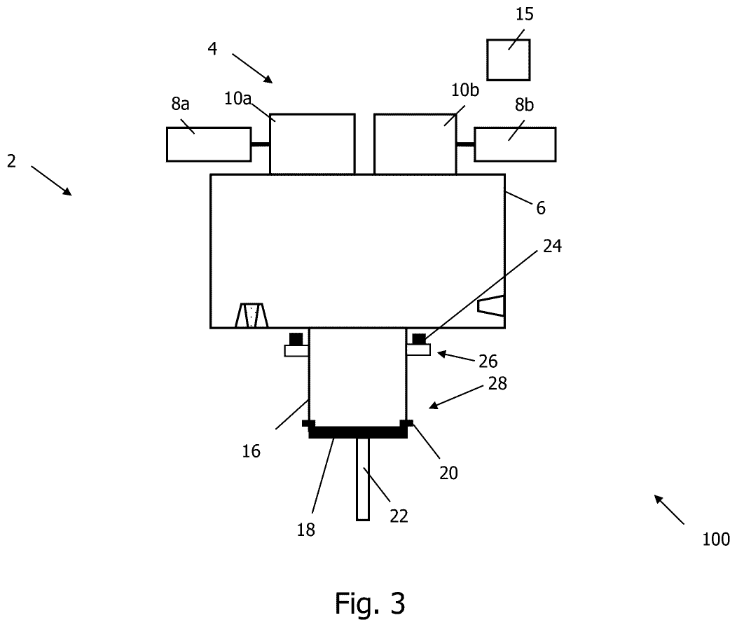

FIG. 3 shows a schematic drawing of a production system with the build cylinder coupled thereto;

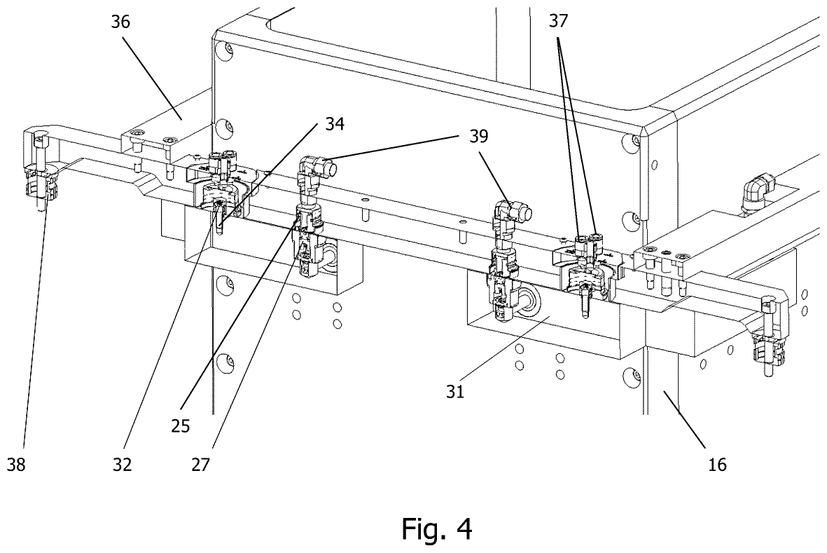

FIG. 4 shows a perspective view of a coupling system with the build cylinder coupled thereto;

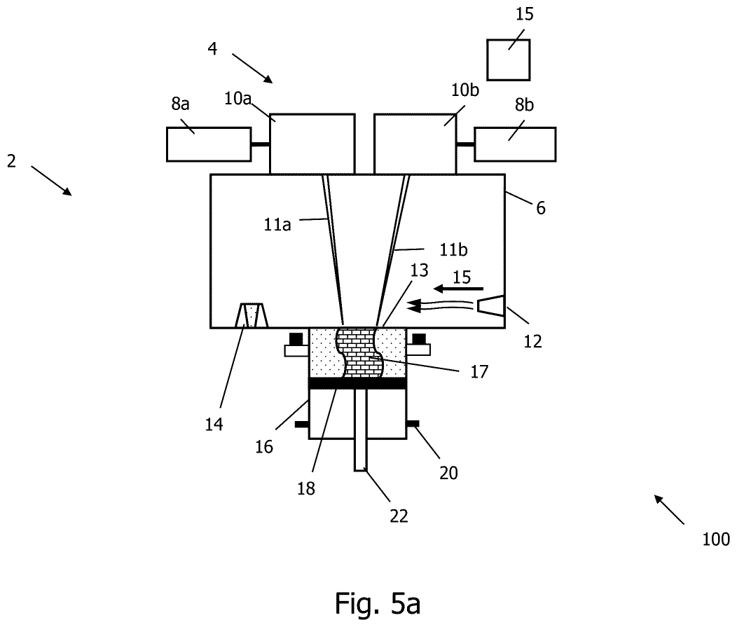

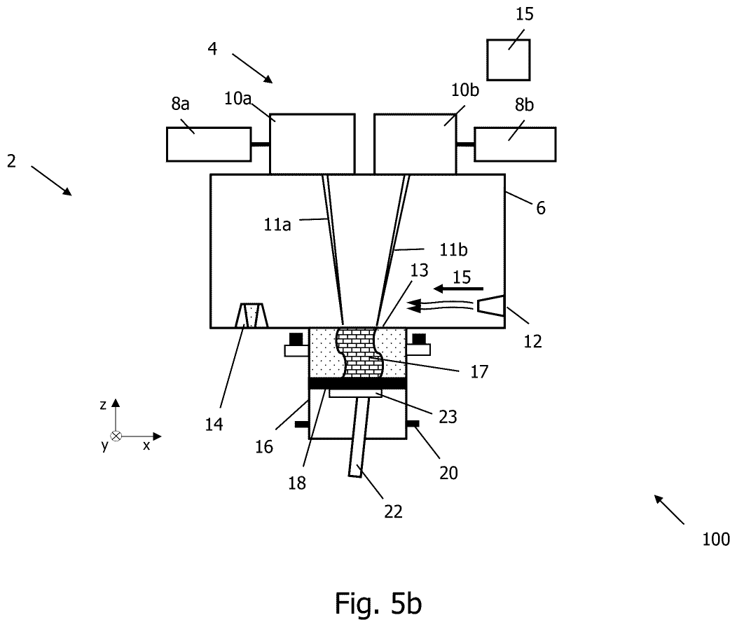

FIG. 5a shows a schematic drawing of a production system with the build cylinder coupled thereto, during a production process;

FIG. 5b shows a schematic drawing of a production system with the build cylinder coupled thereto, during a production process;

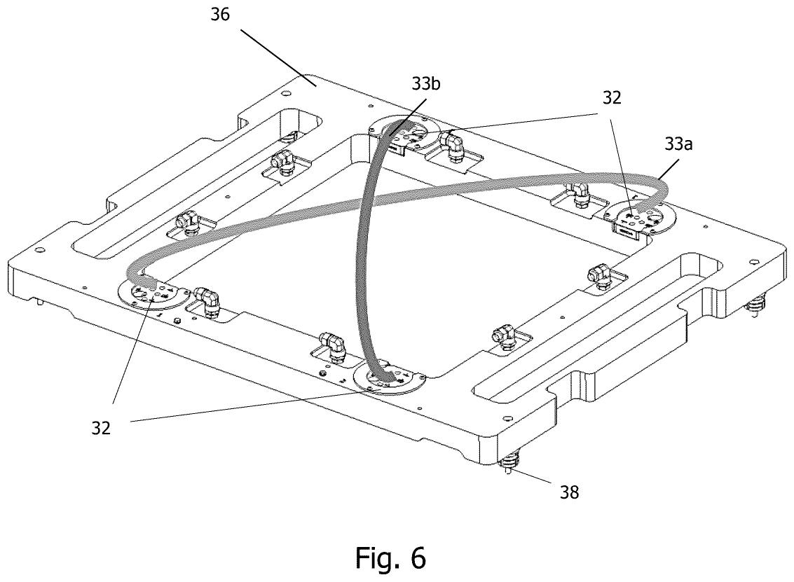

FIG. 6 shows a perspective view of a coupling system and possible fluid circuits;

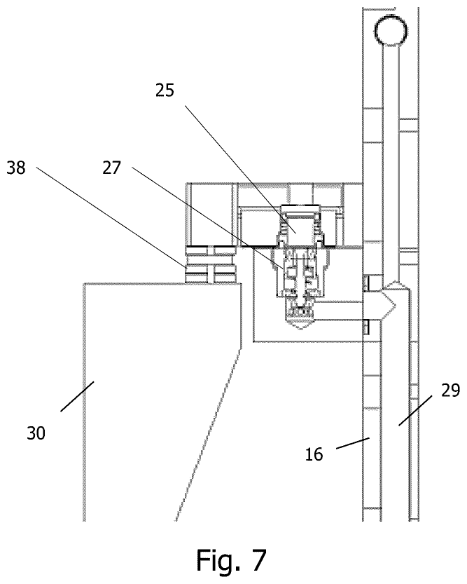

FIG. 7 shows a cross-sectional view through fluid interfaces of a coupling system and build cylinder; and

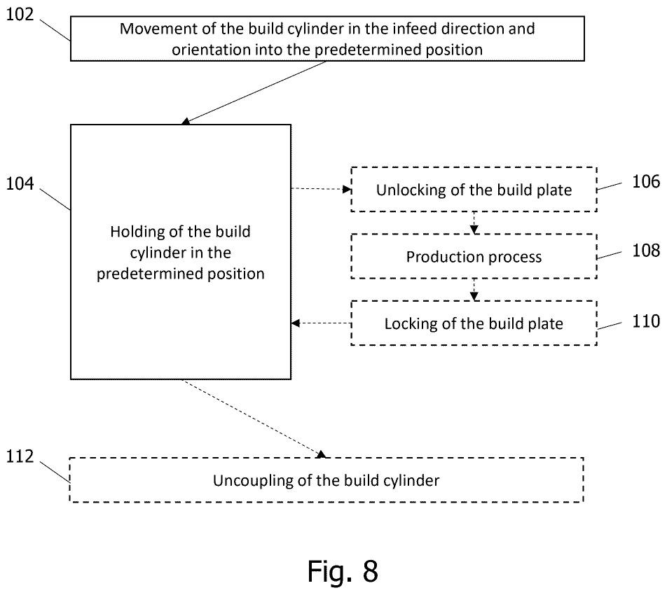

FIG. 8 shows a flow diagram of a method according to the present disclosure.

In the following, reference signs denote the same structural and/or functional features.

FIGS. 1, 3 and 5a show a production system 100 in different stages. The system 100 comprises a production apparatus 2 for additive manufacturing of three-dimensional workpieces, which apparatus has a solidifying device 4 and in particular a process chamber 6. The solidifying device 4 is adapted to selectively solidify powder material and can have for this purpose multiple radiation sources 8a, 8b and scanners 10a, 10b, which are designed to deflect the beams 11a, 11b over a powder layer 13. The radiation sources 8a, 8b can be laser sources. The process chamber 6 can be supplied with gas, for example protecting gas, via a gas inlet 12. A gas outlet 14 can be provided, via which gas can escape from the process chamber 6. A desired gas stream 15 can thus be provided in the process chamber 6 and can serve in particular to convey particles that form during the production process out of the process chamber 6. A control device 15 can be provided, said control device being adapted to control the system 100, the production apparatus 2 or individual components thereof, in particular in order to carry out the method described herein.

The system 100 further comprises a build cylinder 16, a build plate 18 and a drive device 22. The build cylinder 16 is exchangeable for build cylinders that in particular are structurally identical. In other words, the production apparatus 2 is adapted for use with an exchangeable build cylinder designed to receive at least partially solidified powder material. The build plate 18 is displaceably mounted in the build cylinder 16. A locking system 20 can lock the build plate 18 relative to the build cylinder 16 so that, when the build plate 18 is raised, not only the build plate 18 but also the build cylinder 16 is raised upward. A drive device 22, in particular a linear drive, is provided for raising and lowering the build plate.

In FIG. 1 the build cylinder 16 is uncoupled from the production apparatus 2, in FIG. 3 the build cylinder 16 is coupled to the production apparatus 2, according to FIG. 5a the build cylinder 16 is coupled to the production apparatus 2 and a production process for the layer-wise manufacturing of a three-dimensional workpiece 17 by selective solidification of individual layers by means of the solidifying device 4 is being carried out.

A coupling system 24 is provided for coupling the build cylinder 16 to the production apparatus 2. The coupling system 24 is designed to orient the build cylinder 16 in a predetermined position and to hold it in the predetermined position at least during part of a production process.

FIGS. 2 and 4 show perspective views of an exemplary coupling system 24 in different states. In the uncoupled or free state according to FIG. 2, the build cylinder 16 is uncoupled from the production apparatus 2, the coupling system 24 is thus unoccupied. This corresponds to the stage according to FIG. 1. In the coupled state according to FIG. 4, the build cylinder 16 is coupled to the production apparatus 2, the coupling system 24 is thus occupied. This corresponds to the stages according to FIGS. 3 and 5a.

For coupling with the coupling system 24, the build cylinder 16 is moved upward, as is shown, for example, in FIGS. 1 and 3. The precise positioning of the build cylinder 16, in particular in spatial directions that are different from the movement direction (e.g. to the left and/or into the plane of the drawing in FIG. 1), is here ensured by the coupling system 24. In particular, the coupling system 24 is designed such that, on coupling of the build cylinder 16 to the production apparatus 2, it urges an upper end portion 26 of the build cylinder 16 into the predetermined position and, after coupling, holds the build cylinder suspended by this upper end portion 26, at least during part of the production process. The coupling system 24 can be adapted such that it holds substantially the entire weight of the build cylinder 16 when the build cylinder is coupled on and the locking system 20 has unlocked the build plate 18. The locking device 20 is preferably arranged in a lower end portion 28 of the build cylinder 16.

The system 100 can further comprise a support device 30, as is indicated schematically in FIG. 1. The coupling system 24, the process chamber 6 and/or the solidifying device 4 can be carried by the support device 30. The support device 30 is preferably designed such that the weight of the coupled-on build cylinder 16 borne by the coupling system 24 has no influence on the spatial position of the process chamber 6 and/or of the solidifying device 4.

The coupling system 24 can comprise four clamping systems 32, which hold the build cylinder 16 in the predetermined position after coupling. In order to be able to securely clamp the build cylinder 16, the four clamping systems 32 can be arranged at the corners of the build cylinder 16 when the build cylinder is coupled on. Each clamping system 32 can correspond to a clamping module, which is adapted to clamp a clamping means 34, in particular a clamping bolt. The clamping means 34 is preferably fastened to the upper end portion 26 of the build cylinder 16. The clamping means can be a clamping bolt with a beveled upper side, which can ensure simple orientation of the build cylinder 16 and can prevent canting of the clamping means in the clamping system 32. It is conceivable to use as the clamping means 34 a clamping bolt with a distal chamfer in order to permit an offset of 1-2 mm, a zero bolt, a compensating bolt, a clamping bolt with a locking screw, a sword bolt or an undersize bolt.

The coupling system can comprise a frame-shaped carrier element 36 in which the clamping systems 32 are arranged. The carrier element 36 can lie on the support device 30 via vertically adjustable leveling screws 38. The spatial position of the clamping systems 32 relative to the support device 30, which is preferably rigid and stands on the bottom of the space, can thus be fixed precisely, which in turn permits precise positioning in space of the build cylinder 16 and of the layered powder material to be solidified that is located therein. In a particular configuration, the leveling screws 38 are coupled to the support device 30 such that a reciprocal translation in the x-y plane (e.g. within a predetermined tolerance range of a few millimeters) is possible.

For example, the clamping systems 32, when taken together, form a zero point clamping system, wherein the zero point 35 lies on a central axis of the build cylinder 16. The clamping systems 32 are each mounted so as to be linearly displaceable, so that they can be displaced by a few millimeters along respective straight lines. Each of these straight lines can intersect a central axis of the build cylinder 16. In this way, it can be ensured that the central axis of the build cylinder 16 continues to correspond to the zero point 35 even in the event of a temperature-related expansion of the build cylinder during the production process. In other words, the position of the central axis of the build cylinder 16 can be maintained irrespective of a temperature change of the build cylinder 16.

The clamping systems 32 can be configured as pneumatic controllable clamping modules, so that they are able to be opened, closed, unlocked, locked, cleaned and/or re-tightened pneumatically. To this end, multiple independent fluid circuits 33a, 33b can be used. In particular, different clamping systems 32 can be supplied via different fluid circuits. As indicated in FIG. 6, in particular clamping systems 32 of the plurality of clamping systems 32 that are arranged opposite one another can be controllable via the same fluid circuit 33a or 33b. Preferably, the clamping modules are normally preloaded, so that the clamping means continue to remain clamped even in the event of a power failure and/or a failure of the pneumatic supply. In the case of electrically switchable clamping systems 32, individual subgroups of the clamping systems 32 can correspondingly be activated via different power and/or control circuits, for example in pairs.

The coupling system 24 can also have functional interfaces such as, for example, plug-in electrical interfaces or quick-coupling fluid interfaces. In FIGS. 4 and 7, fluid interfaces 25 are shown by way of example. The build cylinder 16 has in this case corresponding counter-interfaces 27, for example on projections 31 provided on the outer circumferential side in the upper end portion 26 of the build cylinder 16. The fluid interfaces can serve in particular to supply a temperature-control system of the build cylinder 16. This temperature-control system can comprise a fluid conducting system 29, which is provided on or in the build cylinder 16.

On an upper side of the carrier element 36 there can be provided feed connections 37, which serve to pneumatically control the clamping systems 32. Fluid connections 39 connected to the fluid interfaces 25 can further be provided.

It may be that the drive device 22 is not oriented optimally in relation to the process chamber 6, or that the orientation of the drive device 22 changes over time (e.g. during the displacement of the build plate 18 upward in the z-direction). In order to prevent undesirable displacement or/and twisting of the build plate 18 in such cases, the drive device 22 can be coupled to the build plate 18 so as to be movable in translation in the x-y plane and in rotation about the x- and y-axes. In particular, as shown in FIG. 5b, the build plate 18 can be carried by a carrier plate 23. For the movable coupling of the drive device 22 to the build plate 18, the carrier plate 23 can be configured to be movable in relation to the build plate or/and in relation to the drive device 22.

A further possibility for avoiding undesirable loading of the build plate due to a misorientation of the drive device 22 is to design the coupling system 24, alternatively or in addition to a movable (e.g. indirect) coupling of the drive device 22 to the build plate 18, such that it holds the build cylinder 16 in the coupled-on state so that it is movable in translation in the x-y plane over a predetermined translation range. In this case, the coupling system is thus designed to hold the build cylinder 16 in the predetermined position within a predetermined tolerance (e.g. a few millimeters). In order to realize this, undersize bolts, for example, or/and clamping systems that are displaceable in the x-y plane can be used.

FIG. 8 shows a flow diagram of a method using the system 100.

In step 102, the build cylinder 16 is moved in the infeed direction. The build cylinder 16 is here oriented into the predetermined position by the coupling system 24. In particular, the locking device 20 can lock the build plate 18 relative to the build cylinder 16, and the drive device 22 can move the build plate in the infeed direction, whereby the build cylinder 16 is at the same time moved in the infeed direction. Before the build cylinder 16 is moved, the system 100 is in the configuration according to FIG. 1. After step 102 has been carried out, the system 100 is in the configuration according to FIG. 3.

In step 104, the build cylinder is held in the predetermined position by the coupling system. Here too, the system remains in the configuration according to FIG. 3.

In the optional step 106, the build plate 18 is unlocked so that it is then able to move upward within the build cylinder 20, that is to say in the interior or the powder receiving chamber 19 of the build cylinder 16.

In the optional step 108, the production process is carried out, wherein powder material is metered layer-wise onto the build plate 18, the powder layer is selectively solidified by the solidifying device 4, the build plate is lowered by the thickness of a layer, and then a new powder layer is applied. This is illustrated in FIG. 5a.

After the end of the production process, that is to say after the three-dimensional workpiece 17 has been manufactured, the build plate is lowered into its starting position and locked by the locking system 20 in the optional step 110.

In the subsequent optional step 112, the build cylinder 16 is uncoupled in that the drive device 22 moves the locked build plate 18 downward, that is to say away from the process chamber 6. The build cylinder 16 can then be replaced by an empty build cylinder and the method can start again.

It will be appreciated that the examples, variants and exemplary embodiments described herein can be combined with one another. In addition to the advantages mentioned above, further technical advantages are conceivable.

1-15. (canceled)

16. A production apparatus for additive manufacturing of three-dimensional workpieces, comprising a solidifying device that is adapted to selectively solidify powder material, wherein the production apparatus is adapted for use with an exchangeable build cylinder designed to receive at least partially solidified powder material, wherein the production apparatus comprises a coupling system for coupling with the build cylinder, said coupling system being designed to orient the build cylinder in a predetermined position and to hold it in the predetermined position at least during part of a production process.

17. The production apparatus as claimed in claim 16, wherein the coupling system is adapted to orient an upper end portion of the build cylinder in the predetermined position and to hold the build cylinder at the upper end portion at least during the part of the production process.

18. The production apparatus as claimed in claim 16, designed in such a manner that the build cylinder is to be moved in an infeed direction for coupling with the coupling system, wherein the coupling system is adapted to orient the build cylinder into the predetermined position while it is being moved in the infeed direction.

19. The production apparatus as claimed in claim 16, wherein the coupling system comprises a plurality of clamping systems, each of which is adapted to hold the build cylinder in the predetermined position at least during the part of the production process.

20. The production apparatus as claimed in claim 19, wherein the plurality of clamping systems has at least one of the following properties:
the plurality of clamping systems comprises three or more clamping systems;
the plurality of clamping systems comprises one or more zero point clamping systems;
the clamping systems of the plurality of clamping systems are arranged on different sides of the build cylinder when the build cylinder is oriented in the predetermined position;
the clamping systems of the plurality of clamping systems are each displaceably mounted on a line, wherein the line intersects a central axis of the build cylinder when the build cylinder is oriented in the predetermined position;
the clamping systems of the plurality of clamping systems are pneumatically controllable via at least two independent fluid circuits; and/or
the clamping systems of the plurality of clamping systems are configured so as to be normally clamped.

21. The production apparatus as claimed in claim 16, further comprising a support device, wherein the coupling system is carried by the support device and/or the predetermined position is defined relative to the support device.

22. The production apparatus as claimed in claim 16, wherein
the coupling system comprises one or more functional interfaces for connection to matching functional interfaces of the build cylinder.

23. A production system comprising:
a production apparatus for additive manufacturing of three-dimensional workpieces, comprising a solidifying device that is adapted to selectively solidify powder material, wherein the production apparatus is adapted for use with an exchangeable build cylinder designed to receive at least partially solidified powder material, wherein the production apparatus comprises a coupling system for coupling with the build cylinder, said coupling system being designed to orient the build cylinder in a predetermined position and to hold it in the predetermined position at least during part of a production process; and
the build cylinder.

24. The production system as claimed in claim 23, wherein the build cylinder further comprises multiple clamping elements which are designed for coupling with clamping systems of the coupling system, wherein the clamping elements are arranged on different sides of the build cylinder and/or are each displaceably mounted on a line, wherein the line intersects a central axis of the build cylinder.

25. The production system as claimed in claim 23, wherein the build cylinder comprises a fluid conducting system, and a fluid interface for connection to a matching fluid interface of the coupling system and configured to supply the fluid conducting system.

26. The production system as claimed in claim 23, wherein the build cylinder has an upper end portion and an opposite lower end portion, wherein a locking system is arranged at the lower end portion, said locking system being adapted to lock, relative to the build cylinder, a build plate that is displaceably mounted in the powder receiving chamber.

27. The production system as claimed in claim 26, further comprising:
a drive device, which is adapted to raise the build plate while the build plate is locked by the locking system, in order to move the build cylinder in an infeed direction for coupling with the coupling system.

28. A method for coupling a build cylinder to a production apparatus for additive manufacturing of three-dimensional workpieces, the apparatus comprising a solidifying device that is adapted to selectively solidify powder material, wherein the production apparatus is adapted for use with an exchangeable build cylinder designed to receive at least partially solidified powder material, wherein the production apparatus comprises a coupling system for coupling with the build cylinder, said coupling system being designed to orient the build cylinder in a predetermined position and to hold it in the predetermined position at least during part of a production process, comprising:
moving the build cylinder in an infeed direction, wherein the build cylinder is oriented into the predetermined position by the coupling system while it is being moved in the infeed direction; and
holding the build cylinder in the predetermined position by the coupling system, at least during part of the production process.

29. The method as claimed in claim 28, wherein the build cylinder is moved in the infeed direction in that a build plate displaceably mounted in the interior of the build cylinder is raised while the build plate is locked relative to the build cylinder.
